(19) United States
(12) Patent Application Publication
(10) Pub. No.: US 2017/0305335 A1
(43) Pub. Date: Oct. 26, 2017

(54) Indent-Indication System For An Automated Vehicle

(71) Applicant: Delphi Technologies, Inc., Troy, MI (US)

(72) Inventors: Junqing Wei, Bridgeville, PA (US); Jong Ho Lee, Pittsburgh, PA (US); Junsung Kim, Pittsburgh, PA (US)

(21) Appl. No.: 15/135,825

(22) Filed: Apr. 22, 2016

(51) Int. Cl. B60Q 1/46; B60Q 1/34

(52) U.S. Cl. CPC B60Q 1/46; B60Q 1/346; B60Q 2300/33; B60Q 2300/45; B60Q 2300/42

(57) ABSTRACT

An intent-indication system includes an intersection-detector, a vehicle-detector, and a controller. The intersection-detector is suitable for use on a host-vehicle. The intersection-detector is used to determine that the host-vehicle is stopped at an intersection. The vehicle-detector is also suitable for use on the host-vehicle. The vehicle-detector is used to detect a presence of an other-vehicle proximate to the intersection. The controller is in communication with the intersection-detector and the vehicle-detector. The controller is configured to operate host-headlights of the host-vehicle to provide an indication of intent of the host-vehicle to the other-vehicle when the host-vehicle and the other-vehicle have been stopped at the intersection for more than a time-threshold.

### TECHNICAL FIELD OF INVENTION

This disclosure generally relates to an intent-indication system for an automated vehicle, and more particularly relates to a system that operates host-headlights of a host-vehicle to provide an indication of intent of the host-vehicle to another-vehicle when the host-vehicle and the other-vehicle have been stopped at the intersection for more than a time-threshold.

### BACKGROUND OF INVENTION

Fully automated or autonomous vehicles have been proposed where an operator of a host-vehicle is little more than a passenger of the vehicle, merely indicating a destination for the automated vehicle. However, situations may occur when normal right-of-way rules are unable to resolve a situation because, for example, multiple vehicles simultaneously arrive at an intersection.

### SUMMARY OF THE INVENTION

In accordance with one embodiment, an intent-indication system for an automated vehicle is provided. The system includes an intersection-detector, a vehicle-detector, and a controller. The intersection-detector is suitable for use on a host-vehicle. The intersection-detector is used to determine that the host-vehicle is stopped at an intersection. The vehicle-detector is also suitable for use on the host-vehicle. The vehicle-detector is used to detect a presence of an other-vehicle proximate to the intersection. The controller is in communication with the intersection-detector and the vehicle-detector. The controller is configured to operate host-headlights of the host-vehicle to provide an indication of intent of the host-vehicle to the other-vehicle when the host-vehicle and the other-vehicle have been stopped at the intersection for more than a time-threshold.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of an intent-indication system for operating an automated vehicle in accordance with one embodiment; and

FIG. 2 is traffic scenario encountered by the system of FIG. 1 in accordance with one embodiment.

### DETAILED DESCRIPTION

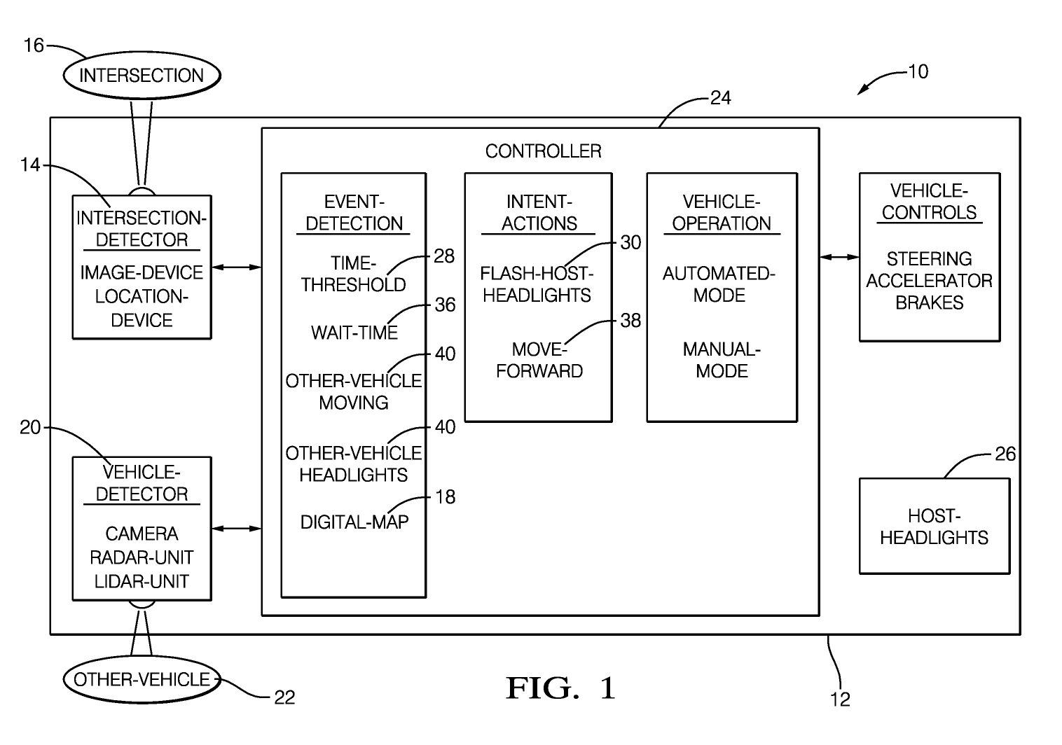

FIG. 1 illustrates a non-limiting example of a system 10 for operating an automated host-vehicle, hereafter referred to as the host-vehicle 12. While the non-limiting examples presented herein are generally related to fully-automated vehicles, i.e. autonomous-vehicles, it is contemplated that the teachings presented herein are also applicable to vehicles that are less than fully-automated, i.e. partially-automated, where an operator (not shown) may manually control some aspect of the host-vehicle 12 such the steering, but the operation of the accelerator and brakes is automated to maintain a predetermined distance behind another vehicle forward of the host-vehicle 12.

The system 10 includes an intersection-detector 14 suitable for use on the host-vehicle 12. The intersection-detector 14 is generally used by the system 10 to determine that the host-vehicle 12 is stopped at or approaching the intersection 16. However, as will become apparent in the description that follows, the specific sensors that constitute the intersection-detector 14 may be used for other aspects of detection and/or determination of the environment in which the host-vehicle 12 resides. The intersection-detector 14 may be a camera, lidar-unit, radar-unit, or any combination thereof. If a camera is used to detect the intersection 16, the camera may be one of a plurality of cameras mounted at various locations on the host-vehicle 12 to form, for example, a 360 degree field-of-view type image-device. Alternatively, or in combination with the image-device, the intersection-detector 14 may include a location-device such a global-positioning-system (GPS) receiver that can be used to determine the location of the host-vehicle 12 on a digital-map 18.

The system 10 also includes a vehicle-detector 20 suitable for use on the host-vehicle 12. The vehicle-detector 20 is generally used to detect the presence and/or motion of an other-vehicle 22 proximate to the intersection 16. By way of example and not limitation, the vehicle-detector 20 may include any one or combination of a camera, a radar-unit, a lidar-unit, an ultrasonic-transducer, or any other sensor technology useful to detect the other-vehicle 22 or objects proximate to the host-vehicle 12. The function of the vehicle-detector 20 may also be provided or supplemented by a transceiver (not shown) configured for vehicle-to-infrastructure (V2I) communications, vehicle-to-vehicle (V2V) communications, and/or vehicle-to-pedestrian (V2P) communications, which may be generically labeled as V2X communications, as will be recognized by those in the art.

The system 10 also includes a controller 24 in communication with the intersection-detector 14 and the vehicle-detector 20. It is recognized that in some traffic situations the host-vehicle 12 and the other-vehicle 22 may arrive at the intersection 16 at approximately the same instant, e.g. less than +/−1 second of each other, so the typical right-of-way driving-rules may not be sufficient to resolve the conflict or dilemma of which of the host-vehicle 12 and the other-vehicle 22 should proceed first into the intersection 16. As will be explained in more detail below, the system 10 is advantageously configured to overcome this problem of which vehicle should proceed first.

The controller 24 may include memory (not specifically shown), including non-volatile memory, such as electrically erasable programmable read-only memory (EEPROM) for storing one or more routines, thresholds, and captured data. The one or more routines may be executed by the processor to perform steps for when the host-vehicle 12 and the other-vehicle 22 arrive at or approach the intersection 16 at about the same time based on signals received by the controller 24 from the intersection-detector 14 and the vehicle-detector 20 as described herein. To overcome the problem determining which vehicle should go first of when the host-vehicle 12 and the other-vehicle 22 arrive at the intersection 16 at approximately the same instant or moment in time, the controller 24 is advantageously configured to operate the host-headlights 26, i.e. flash-host-headlights 30, of the host-vehicle 12 to provide an indication of intent of the host-vehicle 12 to the other-vehicle 22 when or after the host-vehicle 12 and the other-vehicle 22 have been stopped at the intersection for more than a time-threshold 28, three seconds (3s) for example. By way of example and not limitation, the flashing or activation of the host-headlights 26 is generally acknowledged to be interpreted as an indication that that the host-vehicle 12 is inviting the other-vehicle 22 to proceed first into the intersection 16.

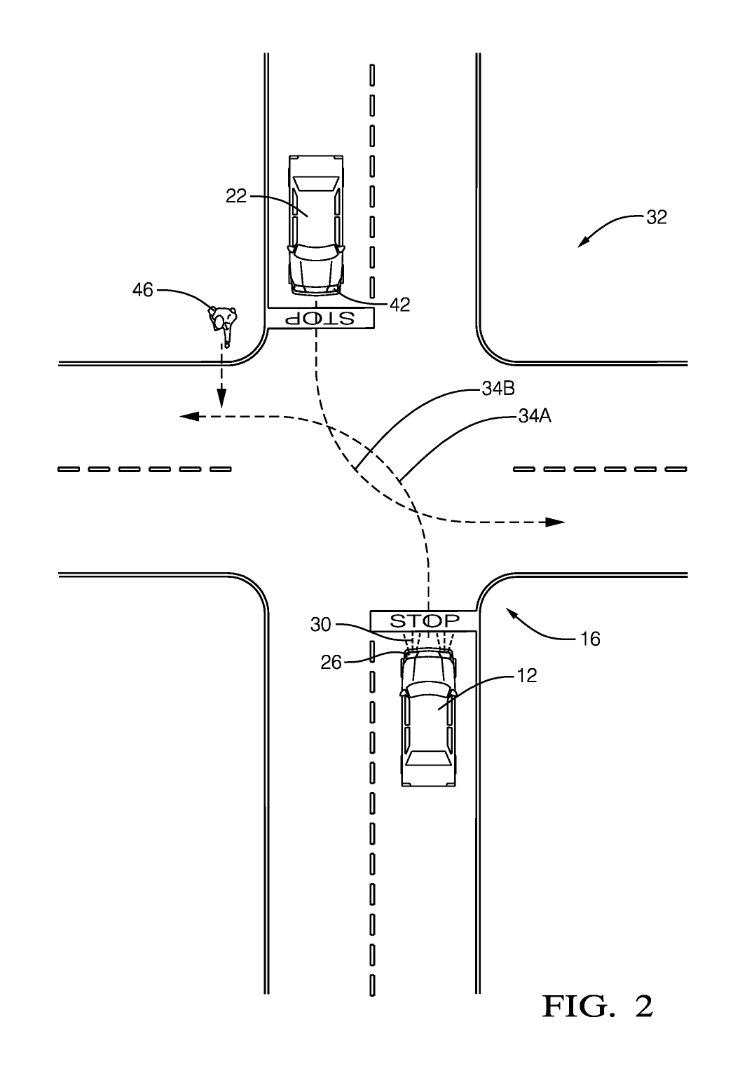

FIG. 2 illustrates a non-limiting example of a traffic-scenario 32 where the host-vehicle 12 and the other-vehicle 22 have arrived at the intersection 16 at essentially the same instant in time. In this example, both the host-vehicle 12 and the other-vehicle 22 intend to make left turns; and the travel-paths 34A, 34B of, respectively, the host-vehicle 12 and the other-vehicle 22 interfere with each other. That is, the configuration of the intersection 16 is such that the host-vehicle 12 and the other-vehicle 22 cannot proceed into the intersection 16 simultaneously without colliding with each other. While FIG. 2 shows a two-way stop where any cross-traffic (none shown) is not required to stop at the intersection 16, it is recognized that the teachings presented herein are applicable to other configuration of intersections such as an intersection characterized as a four-way stop, and that the teachings presented herein can be used to resolve conflicts when two or more vehicles arrive simultaneously at the four-way stop.

It is contemplated that the host-vehicle 12 may encounter instances of intersections where no signs are posted, two or more vehicles are approaching the un-marked intersection, and the normal or common right-of-way rules are insufficient to determine which of vehicles should proceed into the intersection first. The decision-logic directed to how the host-vehicle 12 should respond in this circumstance may not require the host-vehicle 12 to stop, but rather to slow-down and execute the flash-host-headlights 30 in order to indicate that the host-vehicle 12 intends to let the other-vehicle 22 precede unimpeded, and only stop the host-vehicle 12 if necessary.

In order to resolve the dilemma or conflict created when the host-vehicle 12 and the other-vehicle 22 stop at or approach the intersection 16 at essentially the same instant in time, the controller 24 is configured to determine a wait the time-threshold 28 for the host-vehicle 12 to wait before attempting any action when right-of-way rules are unable to determine when the host-vehicle 12 should proceed into the intersection 16. That is, if the right-of-way rules do not provide for a clear decision, then the problem is overcome by waiting for a period of time, e.g. the time-threshold 28, to see what the other-vehicle 22 does before the host-vehicle 12 takes further action such as encourage or invite the other-vehicle 22 to proceed by flashing or operating the host-headlights 26. It is recognized that if both the host-vehicle 12 and the other-vehicle 22 are being operated in an autonomous or automate-mode and the versions of software in both vehicles are the same, at least with regard as to how to resolve the conflict described above, both vehicles may duplicate each other's actions and thereby be waiting for an unacceptably long time before one of the vehicles attempts to enter the intersection 16. Accordingly, described herein are some alternative ways to select or determine the time-threshold 28 and/or subsequent actions which may help to more quickly resolve the conflict without having to engage persons residing/traveling in either of the vehicles.

In one embodiment the system 10 may include a random-number-generator provided by either a separate hardware device or as a subroutine executed by the controller 24, as will be recognized by those in the art. Based on the value or number output by the random-number-generator, the time-threshold 28 may be set to, for example, one of 0.5 seconds, 1.0 second, 1.5 seconds, or 2.0 seconds. If both the host-vehicle 12 and the other-vehicle 22 are equipped with systems that include random-number-generators, then it is more unlikely than likely that both vehicles will duplicate each other's actions. If both vehicle happen to select the same value for the time-threshold 28 based on the output of the random-number-generator, then both vehicles may operate or flash their respective headlights at the same instant, and select a new value for the time-threshold 28. Eventually only one vehicle will flash headlights so the other will begin to enter the intersection while the one waits.

Accordingly, the controller 24 may be further configured to wait a wait-time 36 after the host-headlights 26 of the host-vehicle 12 are operated before any subsequent action to allow the other-vehicle 22 additional time to move into the intersection 16. The wait-time 36 may have a different value when compared to the time-threshold 28, and the wait-time 36 may be a pre-programmed value, or be based on the output or the random-number-generator described above. By way of example and not limitation, the controller 24 may be further configured to move-forward 38 the host-vehicle 12 into the intersection 16 after the wait-time 36 has expired. That is, if the flash-host-headlights 30 was not effective to prompt the other-vehicle 22 to go first into the intersection 16, the host-vehicle may begin the move-forward 38, preferably cautiously so if an other-vehicle-moving 40 is detected by, for example, the intersection-detector 14 and/or the vehicle-detector 20, the host-vehicle 12 will have time to stop and avoid a collision with the other-vehicle 22.

Since it is recognized that the other-vehicle 22 may be configured to operate in the same manner as the host-vehicle 12, it is contemplated that sensors used by the vehicle-detector 20 and/or the intersection-detector 14 may also be used to detect an other-vehicle-headlights 40, i.e. operation of other-headlights 42 on the other-vehicle 22, which may be interpreted to be an invitation by the other-vehicle 22 for the host-vehicle to move-forward 38 into the intersection 16. That is, the controller 24 may be configured to operate the host-vehicle 12 into the intersection when the other-vehicle 22 flashes the other-headlights 42, i.e. the other-vehicle-headlights 40 are detected.

In another embodiment, it is contemplated that sensors used by the vehicle-detector 20 and/or the intersection-detector 14 may also be used to detect a pedestrian 46 proximate to the intersection 16, and the time-threshold 28 and/or wait-time 36 is set to indefinite, i.e. wait for the pedestrian 46 to go first, if the pedestrian 46 is attempting to enter the intersection 16. The controller 24 may be equipped with a pedestrian-intent algorithm that uses, for example, image processing of an image from a camera to determine which way the pedestrian 46 is facing, and if the pedestrian is moving in a direction that will intersect with the travel-path 34A of the host-vehicle 12. Alternatively, if the pedestrian 46 is moving in a direction that intersects only the travel-path 34B of the other-vehicle 22, the host-vehicle 12 may elect to proceed into the intersection 16 without waiting because the other-vehicle will be waiting for the pedestrian 46 to clear the intersection 16. Similarly, if a third vehicle (not shown) is already in the intersection 16 and moving in a direction that intersects only the travel-path 34B of the other-vehicle 22, the host-vehicle 12 may elect to proceed into the intersection 16 without waiting or operating the host-headlights 26 because the other-vehicle 22 will be waiting for the third vehicle to clear the intersection 16.

Accordingly, an intent-indication system (the system 10), a controller 24 for the system 10, and a method of operating the system 10 is provided. The system 10 makes use of the host-headlights 26 of the host-vehicle 12 to communicate an ‘intent’ or ‘invitation to proceed’ to the other-vehicle 22 and/or the pedestrian 46. The system 10 also detects the other-vehicle-headlights 40 operation of the other-headlights 42 by the other-vehicle 22 to as an invitation to the host-vehicle 12 to enter the intersection 16

While this invention has been described in terms of the preferred embodiments thereof, it is not intended to be so limited, but rather only to the extent set forth in the claims that follow.

We claim:

1. An intent-indication system for an automated vehicle, said system comprising:
an intersection-detector suitable for use on a host-vehicle, said intersection-detector used to determine that the host-vehicle is stopped at an intersection;
a vehicle-detector suitable for use on the host-vehicle, said vehicle-detector used to detect a presence of an other-vehicle proximate to the intersection; and
a controller in communication with the intersection-detector and the vehicle-detector, said controller configured to operate host-headlights of the host-vehicle to provide an indication of intent of the host-vehicle to the other-vehicle when the host-vehicle and the other-vehicle have been stopped at the intersection for more than a time-threshold.

2. The system in accordance with claim 1, wherein the intersection-detector includes one of a image-device and a location-device.

3. The system in accordance with claim 1, wherein the controller is further configured to wait a wait-time after the host-headlights of the host-vehicle are operated before any subsequent action to allow the other-vehicle time to move into the intersection.

4. The system in accordance with claim 3, wherein the controller is further configured to move-forward the host-vehicle into the intersection after the wait-time has expired.

5. The system in accordance with claim 1, wherein the vehicle-detector is also used to detect operation of other-headlights on the other-vehicle, and the controller operates the host-vehicle into the intersection when the other-vehicle flashes the other-headlights.
